(19) United States
(12) Patent Application Publication
(10) Pub. No.: US 2007/0094309 A1
(43) Pub. Date: Apr. 26, 2007

(54) Data transfer device

(76) Inventors: Jonathan Peter Buckingham, Stoke Gifford (GB); Gregory Keith Trezise, Stoke Gifford (GB); Andrew Hana, Stoke Gifford (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/493,908

(22) Filed: Jul. 25, 2006

(30) Foreign Application Priority Data
Oct. 11, 2005 (GB) 0520605.7

(51) Int. Cl. G06F 17/30

(52) U.S. Cl. 707/202

(57) ABSTRACT

A data transfer device for exchanging data between a host device and a removable data storage item, wherein data are encrypted or decrypted by the data transfer device during data exchange, whilst permitting interchange with non-encrypting devices.

### FIELD OF THE INVENTION

The present invention relates to a data transfer device for exchanging data between a host device and a removable data storage item, wherein data are encrypted or decrypted by the data transfer device during data exchange.

### BACKGROUND OF THE INVENTION

Data backup is a valuable tool in safeguarding important data. Data are generally backed-up onto removable data storage items, such as tape cartridges or optical discs, such that the backup data may be stored at a different geographical location to the primary data.

By storing important data onto removable data storage items, security issues become a consideration. For example, a visitor to a site might easily pocket a tape cartridge storing large amounts of commercially sensitive data.

Many backup software packages provide the option of encrypting data prior to backup. A drawback with this approach, however, is that the same software package must be used in order to retrieve and decrypt the backup data. Accordingly, backup data cannot be recovered using other legitimate systems where the backup software is not provided. Additionally, software encryption increases the time required to backup data and consumes valuable computer resources.

### SUMMARY OF THE INVENTION

The present invention provides a data transfer device for storing data to a removable data storage item, the data transfer device being operable to: receive data to be stored as one or more records; encrypt the records to create pseudo-records; format the pseudo-records; and store the formatted pseudo-records to the removable data storage item.

Preferably, formatting comprises partitioning the pseudo-records into one or more data blocks, each data block having the same predetermined size, and storing comprises storing the data blocks to the removable data storage item.

Advantageously, formatting comprises packing the pseudo-records together to form a data stream and partitioning the data stream into the data blocks.

Conveniently, formatting comprises compressing each pseudo-record prior to packing.

Preferably, the data transfer device compresses each pseudo-record using a no-compress compression scheme to insert a codeword as required by a particular format.

Advantageously, formatting comprises appending an end-of-record marker to each pseudo-record.

Conveniently, the pseudo-records are formatted using a data formatting scheme employed by conventional data transfer devices to format data received as one or more records for storing to a removable data storage item.

Preferably, the pseudo-records are formatted using a data formatting scheme selected from one of the generations of LTO or DDS/DAT formats.

Advantageously, the data transfer device is operable to compress the records prior to encryption.

Conveniently, the data transfer device is operable to encrypt the records using block encryption, and to encrypt each record using a different initialisation vector.

Preferably, each encryption block has a predetermined number of bits, and the data transfer device is operable to pad each record with redundant data such that each record is an integral number of the predetermined bits.

Advantageously, the data transfer device is switchable to a bypass mode in which records are not encrypted and the data transfer device is instead operable to: receive data to be stored as one or more records; format the records; and store the formatted records to the removable data storage item.

Conveniently, the data transfer device is a tape drive and the removable data storage item is a tape cartridge.

Another aspect of the invention provides a data transfer device for retrieving and outputting data from a removable data storage item, the data transfer device being operable to: retrieve data from the removable data storage item; format the data to create one or more pseudo-records, each pseudo-record comprising an encrypted record; decrypt a pseudo-record to create a record; and output the record.

Preferably, the data transfer device is operable to retrieve data from the removable data storage item as one or more data blocks, each data block having the same predetermined size and comprising one or more pseudo-records, and unformatting comprises extracting the pseudo-records from the data blocks.

Conveniently, formatting comprises extracting a chunk of data from each data block, packing the chunks of data together to form a data stream and partitioning the data stream into the pseudo-records.

Advantageously, the data are formatted using a data formatting scheme employed by conventional data transfer devices to format data retrieved from a removable data storage item to output a record.

Preferably, the data are formatted using a data formatting scheme selected from LTO and DDS.

Conveniently, the data transfer device is operable to decompress the record prior to output.

Advantageously, the data transfer device is operable to decrypt the pseudo-record using block encryption and each pseudo-record comprises a different initialisation vector.

Preferably, the data transfer device is switchable to a bypass mode in which pseudo-records are not encrypted and the data transfer device is instead operable to: retrieve data from the removable data storage item; format the data to create one or more pseudo-records, each pseudo-record comprising an encrypted record; and output a pseudo-record.

Conveniently, the data transfer device is a tape drive and the removable data storage item is a tape cartridge.

A further aspect of the invention provides a data transfer device for storing data to a removable data storage item, the data transfer device comprising: means for receiving data to be stored, the data being received as one or more records; means for encrypting the records to create pseudo-records; means for formatting the pseudo-records; and means for storing the formatted pseudo-records to the removable data storage item.

Advantageously, the data transfer is suitable for retrieving and outputting data from the removable data storage item, and the data transfer device comprises: means for retrieving data from the removable data storage item; means for formatting the data to create one or more pseudo-records, each pseudo-record comprising an encrypted record; means for decrypting a pseudo-record to create a record; and means for output the record.

Another aspect of the invention provides a method of storing data to a removable data storage item, the method comprising: receiving data to be stored as one or more records; encrypting the records to create pseudo-records; formatting the pseudo-records; and storing the formatted pseudo-records to the removable data storage item.

Preferably, the method is suitable for retrieving and outputting data from the removable data storage item, and the method comprises: retrieving data from the removable data storage item; formatting the data to create one or more pseudo-records, each pseudo-record comprising an encrypted record; decrypting a pseudo-record to create a record; and output the record.

In a further aspect, the present invention provides a computer program product storing computer program code executable by a data transfer device, the computer program product when executed causing the data transfer device to operate as described in the aforementioned aspects of the invention, or to perform the aforementioned methods.

### BRIEF DESCRIPTION OF THE DRAWINGS

In order that the present invention may be more readily understood, embodiments thereof will now be described, by way of example, with reference to the accompanying drawings, in which:

FIG. 1 is a schematic block diagram of a tape drive embodying the present invention; and

FIG. 2 illustrates a record at various stages of formatting by the tape drive of FIG. 1.

### DETAILED DESCRIPTION

In tape formats such as various generations of linear tape-open (LTO) and digital data storage (DDS, including DAT 72 and DAT 160), data to be stored are received by a tape drive as one or more records. The tape drive then formats and compresses the records into a compressed data stream, which is subsequently divided into chunks of data having the same predetermined size. Finally, an information table is appended to each chunk of data to create a data block, which is then written to tape. In the LTO format, the data block is referred to as a data set, whilst in the DDS format, the data block is referred to as a group.

An embodiment of the present invention will now be described in which records are encrypted prior to storage, and the data blocks written to tape continue to conform to a conventional tape format, such as LTO or DDS. Whilst the embodiment is described with reference to the LTO format, the present invention may be equally applied to other formats in which data to be stored are received as one or more records.

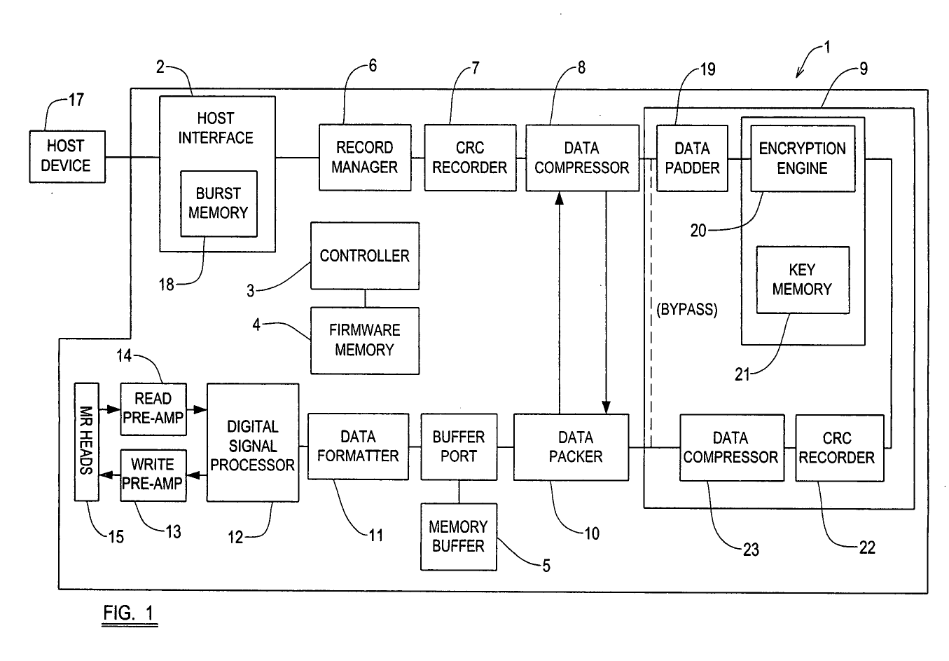

The tape drive 1 of FIG. 1 comprises a host interface 2, a controller 3, a firmware memory 4, a memory buffer 5, a record manager 6, a CRC recorder 7, a data compressor 8, a data encryptor 9, a data packer 10, a data formatter 11, a digital signal processor 12, write 13 and read 14 pre-amplifiers, and magneto-resistive heads 15. With the exception of the data encryptor 9 and the software stored in the firmware memory 4, the components of the tape drive 1 are identical to those employed in conventional LTO tape drives.

The host interface 2 controls the exchange of data between the tape drive 1 and a host device 17. Control signals received from the host device 17 by the interface 2 are delivered to the controller 3, which, in response, controls the operation of the tape drive 1. Data received from the host device 17 typically arrives in high speed bursts and the host interface 2 includes a burst memory 18 for storing data received from the host device 17.

The controller 3 comprises a microprocessor, which executes instructions stored in the firmware memory 4 to control the operation of the tape drive 1.

The record manager 6 retrieves data from the bust memory 18 of the host interface 2 and appends record boundaries. The CRC recorder 7 then appends a cyclic redundancy check (CRC) to each record. Each of the protected records is then compressed by the data compressor 8 using LTO scheme-1 (ALDC) compression. The integrity of the compressed records is then checked by the data compressor 8, which decompresses the records and checks the CRCs. The compressed records are then delivered to the data encryptor 9.

The data encryptor 9 comprises a data padder 19, an encryption engine 20, a key memory 21, a CRC recorder 22 and a data compressor 23. The CRC recorder 22 and data compressor 23 of the data encryptor 9 shall be referred to hereafter as the encrypt CRC recorder 22 and encrypt data compressor 23 so as to distinguish them from the other CRC recorder 7 and data compressor 8.

As described below, the data encryptor 9 employs block encryption, each block having 128 bits. The data padder 19 therefore appends an end-of-record (EOR) codeword to each compressed record and pads each compressed record with redundant data (e.g. with zeros) such that each compressed record is an integral number of 128 bits.

The encryption engine 20 employs a Galois Counter Mode (GCM) encryption algorithm to encrypt each padded, compressed record. The key memory 21 may be volatile or non-volatile, depending on the intended applications of the tape drive 1, and stores a 256-bit encryption key that is used by the encryption engine 20. Other keys such as a 128 or a 192 bit key may also be used. The Galois/Counter Mode is specified in “The Galois/Counter Mode of Operation” by David A. McGrew and John Viega available from NIST/CSRC.

The encryption engine 20 divides each padded, compressed record into blocks of 128 bits. Each block is then encrypted using the encryption key held in key memory 21 and a counter value.

After data encryption, the encryption engine 20 appends an initialisation vector (sometimes referred to as an initial vector) to the beginning of the blocks of ciphertext and an authentication tag to the end of the blocks of ciphertext to create a pseudo-record. The initialisation vector is the counter value for the first block of ciphertext of the pseudo-record (i.e. block number=0), whilst the authentication tag is generated in accordance with the GCM specification and comprises a form of checksum generated over the data of a record. The tag may also be generated over any additional authenticated data (MD) which may or may not be prefixed to records. The tag, MD and prefixing MD to records are all concepts enshrined in the GCM and IEEE1619.1 standards. Please note that during restore, a tag is regenerated over the record and over any MD and checked with the tag previously generated.

The pseudo-record, comprising the IV, blocks of ciphertext and authentication tag, is delivered to the encrypt CRC recorder 22, which appends a CRC to the pseudo-record to create a protected pseudo-record. The protected pseudo-record is then delivered to the encrypt data compressor 23, which compresses the protected pseudo-record using LTO scheme-2 (no-compress) compression. Owing to encryption, the pseudo-record comprises random data and therefore the pseudo-record is incompressible. It is for this reason that scheme-2 compression is employed. Although no compression is actually achieved, the compressed pseudo-record consists of LTO codewords (e.g. compression, scheme and reset codewords). Consequently, the compressed pseudo-record is LTO compliant.

The compressed encrypted pseudo-record is then delivered to the data packer 10, which appends an EOR codeword to the compressed pseudo-record and packs sequential compressed pseudo-records together to form a compressed data stream, which is then written to the memory buffer 5.

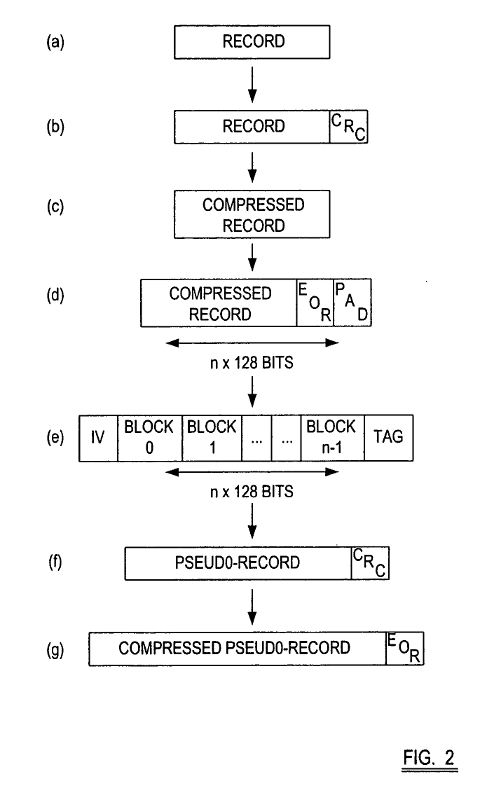

FIG. 2 illustrates a record received from the host device 17 at various stages of formatting by the tape drive 1. FIG. 2(a) illustrates the record as received by the tape drive 1, which may be of any size. FIG. 2(b) illustrates the record after processing by the CRC recorder 6, and FIG. 2(c) illustrates the protected record after compression by the data compressor 7. FIG. 2(d) illustrates the compressed record after formatting by the data padder 19. FIG. 2(e) illustrates the pseudo-record created after encryption. FIG. 2(f) illustrates the pseudo-record after processing by the encrypt CRC recorder 22, and FIG. 2(e) illustrates the protected pseudo-record after compression by the encrypt data compressor 23 and the data packer 10. LTO format specifies also that records must be padded to a 32 bit boundary hence the potential use of a 4-byte pad appended to the end of the pseudo-record.

As in conventional LTO tape drives, the controller 3 then divides or partitions the compressed data stream into data chunks of a predetermined size (e.g. 403884 bytes for LTO1/LTO2 and 1616940 for LTO3/LTO4) which includes a data set information table (DSIT) of 468 bytes for LTO1/LTO2/LTO3/LTO4) appended to each data chunk to create a data set. Each data set is then delivered to the data formatter 11, which ECC-encodes the data set, randomises the ECC-encoded data to remove long sequences, and RLL encodes the randomised data. The RLL-encoded data are then processed by the digital signal processor 12 and delivered, via the write pre-amplifier 13, to write head elements 15 which write the data set to a magnetic tape.

The read process is basically the reverse of the write process. In response to a request to retrieve a particular record, the tape drive 1 first locates the relevant data set or group of data sets. The data set is then read from the tape by read head elements 16 which generate an analogue signal. The analogue signal is then amplified by the read pre-amplifier 14 and processed by the digital signal processor 12 to generate a digital data stream. The digital data stream is then RLL-decoded, unscrambled and ECC-decoded by the data formatter 11 to create the data set.

The chunk of data corresponding to the data region of the data set is then delivered to the data packer 10, which unpacks the chunk of data to create one or more compressed pseudo-records. The location of each compressed pseudo-record is determined by the EOR codewords previously appended by the data packer 10 during data storage.

Each compressed pseudo-record is then decompressed by means of the encrypt data compressor 23. The CRC appended to each pseudo-record is discarded by the encrypt data compressor 23 and the resulting pseudo-records are delivered to the encryption engine 20, which then decrypts the pseudo-records. The encryption engine 20 uses the encryption key stored in key memory 21 and the initialization vector stored at the beginning of each pseudo-record to decrypt the pseudo-records and generate in response padded, compressed records.

The padded, compressed records are then delivered to the data compressor 8, which decompresses the records. Owing to the presence of the EOR codeword, the data compressor 8 ignores any padding to the compressed records.

The controller 3 then reads each of the retrieved records in turn until the requested record is identified, whereupon it is delivered to the host device 11 via the host interface 2.

The tape drive 1 is additionally operable to receive a new encryption key from the host device 11. Accordingly, data stored to tape by the tape drive 1 may be encrypted using a plurality of different encryption keys so as to further increase data security.

Receipt of the new encryption key may occur at any time, including during a data write to tape. When received by the tape drive 1, the new encryption key is stored in the key memory 21, replacing the previously stored encryption key. All future records received by the tape drive 1 from the host device 17 are then encrypted using the new encryption key.

In the embodiment described above, the data compressor 8 and encrypt data compressor 23 are provided as separate components. However, since both data compressors 8,23 employ LTO compression, they may be provided as a single component. Alternatively, whilst the data compressor 8 employs LTO scheme-1 compression to compress the records prior to encryption, alternative lossless compression algorithms may be equally employed. Moreover, compression prior to encryption, whilst advantageous, it is not essential and may be omitted.

The tape drive 1 may be regarded as involving two formatting steps. In the first step, records received by the tape drive 1 are compressed and then encrypted to create pseudo-records. In the second step, the pseudo-records are subjected to conventional LTO formatting, i.e. the pseudo-records are protected, compressed using an LTO scheme, and packed together to form a compressed data stream. The tape drive 1 may therefore be regarded as converting records into encrypted pseudo-records which are then formatted by the tape drive 1 using conventional LTO formatting.

By creating pseudo-records, which are then formatted using conventional LTO formatting, data sets stored to tape by the tape drive 1 can be read back using conventional LTO tape drives, i.e. LTO tape drives not having means to encrypt or decrypt data. When a particular record is requested by a host device, a conventional LTO tape drive will locate and retrieve the relevant data set of group of data sets from the tape. The retrieved data set(s) is then formatted in a conventional manner by the LTO tape drive to extract one or more pseudo-records, each pseudo-record comprising an encrypted record. The pseudo-records are then delivered to the host device 17, whereupon they can be decrypted using software resident on the host device. The tape drive 1 therefore has the very real benefit that data stored to tape by the tape drive 1 are encrypted and yet can nevertheless be read back by conventional tape drives and decrypted using software resident on a host device.

The tape drive 1 may optionally include a bypass (see FIG. 1) such that the data encryptor 9 is ignored by the tape drive 1 during data write or data read. Bypass of the data encryptor 9 may occur should no encryption key be stored in key memory 21, or if the controller 3 receives a command from the host device 17 to bypass encryption. With the exception of the data encryptor 9, the components of the tape drive 1 are identical to those of a conventional LTO tape drive. In particular, the data compressor 8 of the tape drive 1 employs an LTO compression scheme. Consequently, when the data encryptor 9 is bypassed, the tape drive 1 functions as a conventional LTO tape drive and records to be stored and/or retrieved are formatted using conventional LTO formatting.

Although an embodiment of the present invention has been described with reference to the LTO format, the present invention is equally applicable to other tape formats in which data to be stored are received as records. In particular, the pseudo-records created by the encryption engine 20 can be formatted as conventional records using alternative tape formats, such as DDS. Importantly, by using conventional tape formatting (e.g. LTO or DDS) to format and write the pseudo-records to tape, data stored to tape by the tape drive 1 can be read back using conventional tape drives. Other formats include SDLT, DLT and proprietary IBM formats.

Whilst the data encryptor 9 employs a Galois Counter Mode encryption algorithm, other encryption algorithms may alternatively be employed, including block cipher, stream cipher, symmetric and asymmetric encryption. In the case of asymmetric encryption, the key memory 21 stores a decryption key in addition to the encryption key.

Although an embodiment of the present invention have been described with reference to a tape drive 1, it will be appreciated that the present invention is equally applicable to other types of data transfer devices, such as optical drives, in which data to be stored are received as one or more records.

With the data transfer device embodying the present invention, the encryption and decryption of backup data is moved from the host device to the data transfer device. The data transfer device need not rely upon special commands or control signals in order to encrypt or decrypt data, but may instead encrypt and decrypt data in response to conventional read and write commands received from the host device. Accordingly, the data transfer device is capable of operating using standard hardware interfaces such as SCSI, PCI, IDE, EISA, USB, FireWire®, Bluetooth®, IrDA etc. Moreover, by initially encrypting and formatting records so as to create pseudo-records, the pseudo-records can then be formatted using conventional data formats such as LTO and DDS. Accordingly, data stored by the data transfer device can be read back using conventional data transfer devices to retrieve the pseudo-records, which can then be decrypted using software or other means not provided by conventional data transfer devices.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A data transfer device for storing data to a removable data storage item, the data transfer device being operable to:
receive data to be stored as one or more records;
encrypt the records to create pseudo-records;
format the pseudo-records; and
store the formatted pseudo-records to the removable data storage item.

2. A data transfer device according to claim 1, wherein formatting comprises partitioning the pseudo-records into one or more data blocks, each data block having the same predetermined size, and storing comprises storing the data blocks to the removable data storage item.

3. A data transfer device according to claim 2, wherein formatting comprises packing the pseudo-records together to form a data stream and partitioning the data stream into the data blocks.

4. A data transfer device according claim 3, wherein formatting comprises compressing each pseudo-record prior to packing.

5. A data transfer device according to claim 4, wherein the data transfer device compresses each pseudo-record using a no-compress compression scheme to insert a codeword as required by a particular format.

6. A data transfer device according to claim 1, wherein formatting comprises appending an end-of-record marker to each pseudo-record.

7. A data transfer device according to claim 1, wherein the pseudo-records are formatted using a data formatting scheme employed by conventional data transfer devices to format data received as one or more records for storing to a removable data storage item.

8. A data transfer device according to claim 7, wherein the pseudo-records are formatted using a data formatting scheme selected from one of the generations of LTO or DDS/DAT formats.

9. A data transfer device according to claim 1, wherein the data transfer device is operable to compress the records prior to encryption.

10. A data transfer device according to claim 1, wherein the data transfer device is operable to encrypt the records using block encryption, and to encrypt each record using a different initialisation vector.

11. A data transfer device according to claim 10, wherein each encryption block has a predetermined number of bits, and the data transfer device is operable to pad each record with redundant data such that each record is an integral number of the predetermined bits.

12. A data transfer device according to claim 1, wherein the data transfer device is switchable to a bypass mode in which records are not encrypted and the data transfer device is instead operable to:
receive data to be stored as one or more records;
format the records; and
store the formatted records to the removable data storage item.

13. A data transfer device according to claim 1, wherein the data transfer device is suitable for retrieving and outputting data from the removable data storage item and is operable to:
retrieve data from the removable data storage item;
format the data to create one or more pseudo-records, each pseudo-record comprising an encrypted record;
decrypt a pseudo-record to create a record; and
output the record.

14. A data transfer device according to claim 13, wherein the data transfer device is operable to retrieve data from the removable data storage item as one or more data blocks, each data block having the same predetermined size and comprising one or more pseudo-records, and formatting the data comprises extracting a chunk of data from each data block, packing the chunks of data together to form a data stream and partitioning the data stream into the pseudo-records.

15. A data transfer device according to claim 13, wherein the data are formatted using a data formatting scheme employed by conventional data transfer devices to format data retrieved from a removable data storage item to output a record.

16. A data transfer device according to claim 1, wherein the data transfer device is a tape drive and the removable data storage item is a tape cartridge.

17. A data transfer device for storing data to a removable data storage item, the data transfer device comprising:
means for receiving data to be stored, the data being received as one or more records;
means for encrypting the records to create pseudo-records;
means for formatting the pseudo-records; and
means for storing the formatted pseudo-records to the removable data storage item.

18. A data transfer device according to claim 17, wherein the data transfer is suitable for retrieving and outputting data from the removable data storage item, and the data transfer device comprises:
means for retrieving data from the removable data storage item;
means for formatting the data to create one or more pseudo-records, each pseudo-record comprising an encrypted record;
means for decrypting a pseudo-record to create a record; and
means for outputting the record.

19. A method of storing data to a removable data storage item, the method comprising:
receiving data to be stored as one or more records;
encrypting the records to create pseudo-records;
formatting the pseudo-records; and
storing the formatted pseudo-records to the removable data storage item.

20. A method according to claim 19, wherein the method is suitable for retrieving and outputting data from the removable data storage item, and the method comprises:
retrieving data from the removable data storage item;
formatting the data to create one or more pseudo-records, each pseudo-record comprising an encrypted record;
decrypting a pseudo-record to create a record; and
output the record.
